(19) United States
(12) Patent Application Publication
(10) Pub. No.: US 2011/0284649 A1
(43) Pub. Date: Nov. 24, 2011

(54) Apparatus and method for the mitigation of rotating wind storms

(76) Inventor: Horace Randolph Crawford, Katy, TX (US)

(21) Appl. No.: 13/068,434

(22) Filed: May 10, 2011

Related U.S. Application Data
(63) Continuation-in-part of application No. 12/070,870, filed on Feb. 20, 2008.

(51) Int. Cl. A01G 15/00

(52) U.S. Cl. 239/2.1; 239/14.1

(57) ABSTRACT

An apparatus and method for the mitigation of rotating wind storms. A preferred embodiment creates a rising column of warm air through the use of a heater combined with a fan or compressor. The rising column of warm air is created directly in the path of a naturally occurring rotating wind storm to help alleviate an atmospheric imbalance and to cool the surface of the Earth and the surrounding air which effectively robs the oncoming naturally occurring rotating wind storm of the warm air it needs to build strength. As a result, there is less energy available to facilitate the growth and destructive ability of the natural rotating wind storm where the Earth was cooled by the man-made column of warm air.

### CROSS REFERENCE TO RELATED APPLICATIONS

This application is a Continuation-In-Part claiming priority benefit from U.S. patent application Ser. No. 12/070,870, filed Feb. 20, 2008 entitled “Mitigation of Rotating Wind Storms.”

### FIELD OF THE INVENTION

The present disclosure relates generally to meteorology and the meteorological phenomena of rotating wind storms such as tornadoes and hurricanes. In particular, it relates to an apparatus and method for initiating man-made rotating wind storms in order to mitigate the strength of naturally occurring rotating wind storms, reduce the duration of their lifecycle, and to minimize their destructive potential.

### BACKGROUND OF THE INVENTION

Rotating wind storms cause severe and costly damage to structures and landscapes and cost the lives of thousands of people. There is considerable literature on the formation of and the destruction wrought by tornadoes and hurricanes. Before the 1950s, the only method of detecting a rotating wind storm was by someone seeing it. However, with the advent of weather radar, areas near a local weather office could get advance warning of severe weather. Using radar, meteorologists could detect thunderstorms likely to produce rotating wind storms from dozens of miles away. Today, most developed countries have a network of weather radars, which remains the main method of detecting signals associated with these storms. Radar measures the velocity and radial direction (towards or away from the radar) of the winds in a storm, and so can spot evidence of rotation in storms from more than a hundred miles away. Today's technology allows the Weather Bureau to generally warn inhabitants of a particular area of the conditions ripe for a tornado or hurricane and to predict a general path of any impending destructive rotating wind storm.

Referring to FIG. 1, it is known, in general, that tornadoes and hurricanes develop because of an atmospheric imbalance caused by thunderstorms which form when a cold front meets a warm front and particularly a class of thunderstorm known as supercells, the severe thunderstorms which produce tornadoes form where cold dry polar air meets warm moist tropical air. Specifically, cooler, dry air is situated above warmer, moist air, where the warmer air tends to rise and the cooler air tends to fall. During this movement of air, rotation may occur.

Referring to FIG. 2, atmospheric imbalance may result in supercells. Supercells may contain mesocyclones, an area of organized rotation a few miles up in the atmosphere, usually 1-6 miles across. Most tornadoes from supercells follow a recognizable life cycle that begins when increasing rainfall drags with it an area of quickly descending cooler air known as the rear flank downdraft (RFD). The downdraft accelerates as it approaches the ground, and drags the supercell's rotating mesocyclone towards the ground with it. As the mesocyclone approaches the ground, a visible condensation funnel appears to descend from the base of the storm, often from a rotating wall cloud. The funnel cloud may become a tornado within minutes of the RFD reaching the ground. Near the center of a tornado, there is a rising chimney of rotating warm air. The rising chimney of warm air is replaced by the downdraft of cooler air as nature attempts to restore atmospheric balance. This replacement of the warm air with cooler air will cool the air near the Earth and the Earth itself.

Initially, the tornado has a good source of warm, moist inflow of air from the Earth's surface to power it, so it grows until it reaches the “mature stage.” The mature stage generally lasts from a few minutes to more than an hour. During that time, a tornado often causes the most damage, and in rare cases can be more than one mile across. Meanwhile, the RFD, now an area of cool surface winds, begins to wrap around the tornado, cutting off the inflow of warm air. Once the rotating wind storm is no longer fed by warm air it begins to dissipate. As the RFD completely wraps around and chokes off the tornado's supply of warm air, the vortex begins to weaken. This is the “dissipating stage,” often lasting no more than a few minutes, after which the tornado stops rotation. As the tornado enters the dissipating stage, its associated mesocyclone often weakens as well, as the rear flank downdraft of cooler air cuts off the inflow of warm air powering it.

The Coriolis effect plays a large part in the large-scale dynamics of the oceans and the atmosphere. In meteorology and oceanography, it is convenient to postulate a rotating frame of reference wherein the Earth is stationary. Centrifugal and Coriolis forces may be explained in this frame of reference. Their relative importance is determined by the applicable Rossby numbers. Tornadoes have high Rossby numbers, so, while tornado-associated centrifugal forces are quite substantial, Coriolis forces associated with tornadoes are for practical purposes negligible.

High pressure systems rotate in a direction such that the Coriolis force will be directed radially inwards, and nearly balanced by the outwardly radial pressure gradient. This direction is clockwise in the northern hemisphere and counter-clockwise in the southern hemisphere. Low pressure systems rotate in the opposite direction, so that the Coriolis force is directed radially outward and nearly balances an inwardly radial pressure gradient. In each case a slight imbalance between the Coriolis force and the pressure gradient accounts for the radially inward acceleration of the system's circular motion.

If a low-pressure area forms in the atmosphere, air will tend to flow in towards it, but will be deflected perpendicular to its velocity by the Coriolis force. A system of equilibrium can then establish itself creating circular movement, or a cyclonic flow. Because the Rossby number is low, the force balance is largely between the pressure gradient force acting towards the low-pressure area and the Coriolis force acting away from the center of the low pressure.

Instead of flowing down the gradient, large scale motions in the atmosphere and ocean tend to occur perpendicular to the pressure gradient. This is known as geostrophic flow. On a non-rotating planet fluid would flow along the straightest possible line, quickly eliminating pressure gradients. Note that the geostrophic balance is thus very different from the case of “inertial motions” which explains why mid-latitude cyclones are larger by an order of magnitude than inertial circle flow would be.

This pattern of deflection, and the direction of movement, is called Buys-Ballot's law. In the atmosphere, the pattern of flow is called a cyclone. In the Northern Hemisphere the direction of movement around a low-pressure area is counter-clockwise. In the Southern Hemisphere, the direction of movement is clockwise because the rotational dynamics is a mirror image there. At high altitudes, outward-spreading air rotates in the opposite direction. Cyclones rarely form along the equator due to the weak Coriolis effect present in this region.

An air or water mass moving with speed “v” subject only to the Coriolis force travels in a circular trajectory called an “inertial circle”. Since the force is directed at right angles to the motion of the particle, it will move with a constant speed, and perform a complete circle with frequency f. The magnitude of the Coriolis force also determines the radius of this circle:

$$R = \frac{v}{2 π f}$$

On the Earth, a typical mid-latitude value for f is 10⁻⁴ s−1; hence for a typical atmospheric speed of 10 m/s the radius is 100 km (62 ml), with a period of about 14 hours. In the ocean, where a typical speed is closer to 10 cm/s, the radius of an inertial circle is 1 km (0.6 ml). These inertial circles are clockwise in the northern hemisphere (where trajectories are bent to the right) and anti-clockwise in the southern hemisphere.

If the rotating system is a parabolic turntable, then f is constant and the trajectories are exact circles. On a rotating planet, f varies with latitude and the paths of particles do not form exact circles. Since the parameter f varies as the sine of the latitude, the radius of the oscillations associated with a given speed are smallest at the poles (latitude=±90°), and increase toward the equator.

It is further known, in general, that tornadoes can be detected before or as they occur through the use of Pulse-Doppler radar by recognizing patterns in velocity and reflectivity data, such as hook echoes, as well as by the efforts of storm spotters. Once the patterns are recognized, the Weather Bureau for that area issues a warning to those areas which are identified to be in the path of a current rotating wind storm or are in an area where conditions are ideal for a rotating wind storm to develop. The Weather Bureau can generally predict the future path of an existing tornado or hurricane and predict those areas where a future rotating wind storm may develop based on these recognized patterns. The Weather Bureau regularly monitors this data and has the capability to issue warnings to those in the predicted path if dangerous weather is imminent.

While predicting the formation of and possible path of a tornado or hurricane has saved many lives, a need exists to mitigate the strength of an existing rotating wind storm which will not only shorten the duration of such a storm but also minimize the damage caused by such a storm. No known methods of mitigation have yielded noteworthy results. Seeding the pertinent area from the sky with various items such as dry ice, silver iodide, explosion rockets, calcium chloride, sea water, micro dust, and carbon black have all been tried with less than satisfactory results.

### SUMMARY OF THE INVENTION

One preferred embodiment provides an apparatus and method to mitigate the strength of tornadoes and hurricanes and thus minimize the resulting damage. The preferred embodiment includes an apparatus that initiates man-made “relief tornadoes or hurricanes” (rotating wind storms) by directing a rotating heat column of air upward. The heated column of air is initiated from a location that is in the predicted path of the naturally occurring rotating wind storm. The column or chimney of rotating rising warm air mimics a naturally occurring tornado or hurricane and begins to relieve the atmospheric imbalance (significant differences in temperature and pressure) that created the naturally occurring rotating wind storm. Simultaneously, the apparatus cools the surface of the Earth where it is located and the surrounding air thus robbing the approaching natural rotating wind storm of the warm, humid air. The preferred embodiment creates man-made “relief” zones on more than one path simultaneously which will decrease the strength of the natural wind storm by cooling the surface of the Earth, be it land or water, and decrease the energy available to a future tornado or hurricane that comes near the path of the man-made relief zone.

Accordingly, an embodiment of the apparatus includes a heater combined with a fan or compressor adjustably mounted by a gimbal to a stationary base securely fixed at the surface of the Earth. The stationary base can be anchored to the ground via concrete piers or out in the gulf or ocean on an apparatus similar to a deep sea oil drilling rig. In the preferred embodiment, the heater and fan or compressor combination is a jet engine. The apparatus further includes sensors to detect wind speeds, wind directions, temperatures, and atmospheric pressures. A first set of sensors are mounted to the base itself to collect surface conditions. A second set of remote sensors are mounted to antennas or tethered to weather balloons to monitor conditions above the surface. A transmitter on the base relays the current atmospheric conditions both at the surface and above the surface to a remote tracking station. The base can be manned or unmanned if severe conditions compromise safety. Turning on and off the thrust of the jet engine and controlling how much thrust to apply is controlled by a controller. The controller has the capability to be operated remotely. The controller, if so desired, can also be programmed to automatically start and stop the heater and fan or compressor combination if weather conditions reach predetermined thresholds and thus present an imminent threat of rotating wind storms. The controller controls how much thrust and when to turn on and off the thrust and at which angle to project the thrust.

An alternate embodiment mounts the base including the first and second set of sensors and the transmitter to a mobile unit where the mobile unit further includes a global positioning satellite (GPS) device to track its movements. The mobile unit can be physically driven by a person or persons or it can be an unmanned remote controlled drone. The mobile unit can be mounted on a road going land vehicle or a water going sea vehicle.

It is further envisioned in an alternate embodiment that a matrix of engines may be combined and directed in closely associated parallel axes to permit sufficient horsepower to be generated to effect a high intensity tornado.

Those skilled in the art will appreciate the above-mentioned features and advantages of the invention together with other important aspects upon reading the detailed description that follows in conjunction with the drawings provided.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a graphical picture of the atmosphere conditions taken during tornado formation.

FIG. 2 is a graphical depiction of tornado formation.

FIG. 3 is a plan view of a preferred embodiment of a station base secured to the ground.

FIG. 4 is a schematic of the communication between components of a preferred embodiment of the apparatus.

FIG. 5 is a plan view of a preferred embodiment of a station base secured to a road going vehicle.

FIG. 6 is a plan view of a preferred embodiment of a station base secured to a water going vehicle.

FIG. 7 is a plan view of a preferred embodiment of a station base secured to a platform over water.

FIG. 8 is a top view showing an impending storm cloud, its projected path, and placement of a plurality of station bases.

FIG. 9 is a plan view showing an approaching storm cloud with rotating wind storm and a plurality of man-made relief columns of heated air rising upward through the storm cloud.

FIG. 10 is a graphical depiction of a matrix embodiment.

FIG. 11 is a graphical depiction of a matrix embodiment creating a vortex

FIG. 12 is a flow chart of the steps involved in initiating a rising column of air to mitigate an identified rotating wind storm.

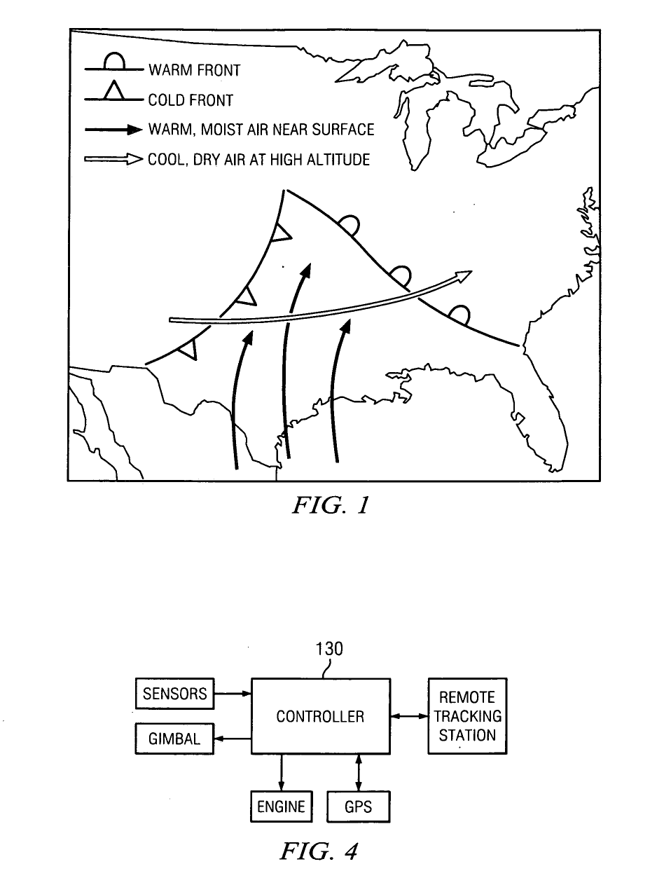

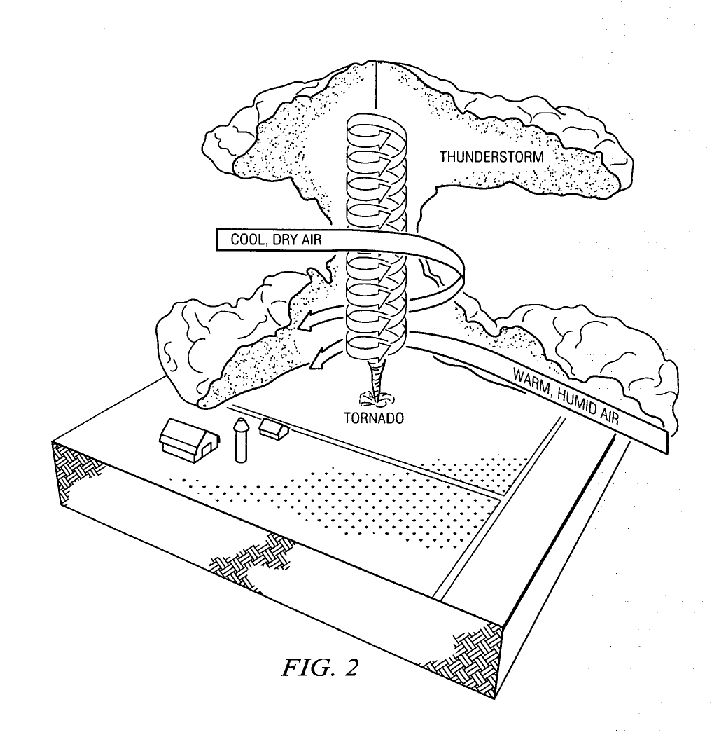

### DETAILED DESCRIPTION OF THE PREFERRED EMBODIMENT

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

While the making and using of various embodiments are discussed in detail below, it should be appreciated that this disclosure provides many applicable inventive concepts which can be embodied in a wide variety of specific contexts. The specific embodiments described herein are merely illustrative of specific ways to make and use the apparatus and do not delimit the scope.

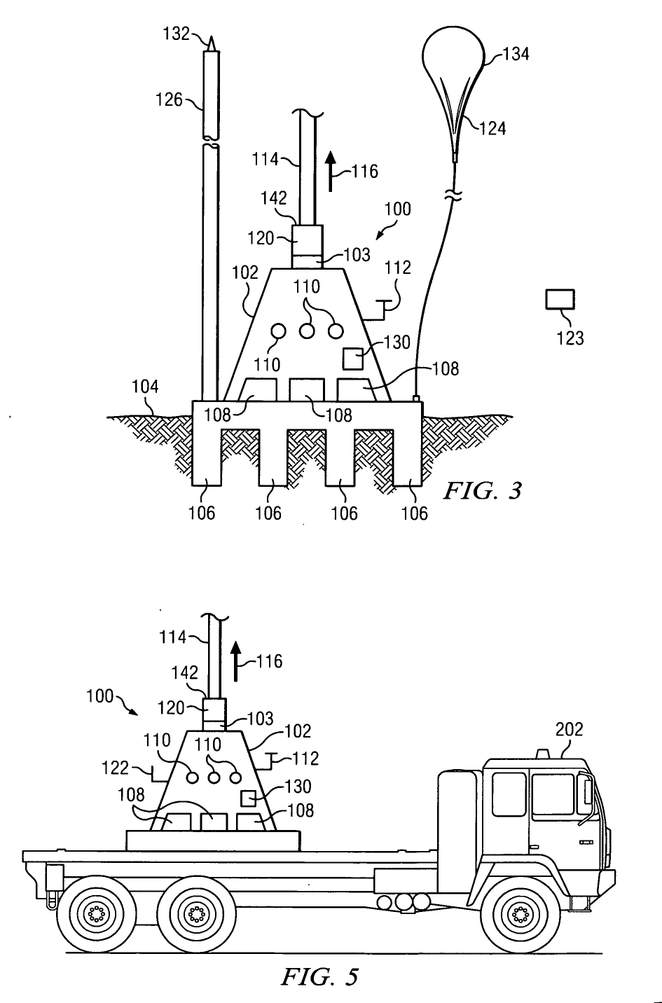

Referring now to FIG. 3, rotating wind storm mitigation device 100 is shown. In a preferred embodiment, device 100 is comprised of base 102 securely entrenched into Earth's surface 104 via a plurality of piers 106. Piers 106 may be integrally formed with base 102, or base 102 may be secured to piers 106 with attachments common in the art. Base 102 and piers 106 may be constructed of concrete or high strength steel or any combination of construction materials designed to withstand high winds as is known in the art. Extending from the top of base 102 is engine 120. In the preferred embodiment, engine 120 is a cylindrically shaped aircraft type jet engine such as those used in a Boeing 707, 737, or 747 aircraft, or powerful military aircraft, and is capable of producing at a minimum 10,000 lbf of thrust and create an air flow rate of approximately 50 m³/second. In an alternate embodiment, engine 120 may be a heater combined with a fan or compressor.

Since the Coriolis effect can be neglected, restoration of a low gradient in pressure across the path of a rotating windstorm will mitigate the creation or severity of the storm. In order to estimate the horsepower required, a maximum intensity tornado capable of EF5 damage, it can be estimated that a tornado having half a kilometer in diameter with a height of three kilometers and using a density of one half atmosphere centered around the middle of the atmosphere (500 kpa) that a conservative tornado would produce between three billion and four billion (3,000,000,000 and 4,000,000,000) horsepower. Additionally, the flow rate of the funnel of a tornado has been estimated to be approximately 6×10⁸ to 6×10⁹ m³ of air per second. It can be estimated that one pound of force in an average jet engine is equivalent to approximately 1 horsepower. In one embodiment, it is estimated that between 300,000 and 350,000 engines at maximum thrust would produce an updraft sufficient to stabilize the unstable atmospheric condition producing an F₅ tornado. In other embodiments, a lesser number of engines may be employed to stabilize smaller storms.

Referring again to FIG. 3, each individual wind storm mitigation device will be further described. Engine 120 is mounted to base 102 via a gimbal 103 to allow for angular adjustments to the thrust vector. Engine 120 is typically pointed generally perpendicular with Earth's surface 104 but is capable of being angled through an altitude range of 0 to 90 degrees from vertical and an azimuth of 360 degrees. Engine 120 includes exhaust outlet 142 while the opposite end is an air intake for the engine formed as a plurality of inlets 108. Inlets 108 are unobstructed openings leading through base 102 and having direct access to engine 120. When operating, warm surface air is inhaled through inlets 108 and into the intake of engine 120 while exhaust 114 is propelled from engine 120 through exhaust outlet 142 and up into the atmosphere in the direction indicated by thrust vector 116. Device 100 further includes sensors 110 which monitor surface temperature, pressure, and wind speed and direction. Controller 130 collects the information gathered by sensors 110 and transmits the information through transmitter 112 to a remote tracking station 123. Tower 126 extends from base 102 and positions sensors 132 above the Earth's surface to monitor conditions in the upper atmosphere. Weather balloon 124 is tethered to base 102 via a high strength cable or rope. Weather balloon 124 positions sensors 134 generally ¼ to 1 mile above Earth's surface to monitor atmospheric conditions above base 102. In a preferred embodiment, tower 126 and weather balloon 124 do not coexist simultaneously but could do so if necessary.

FIG. 4 indicates the flow of communication between the components of device 100.

Sensors 110 measure lower level wind speed, temperature, and air pressure near the Earth's surface while sensors 132 at the top of tower 126 and sensors 134 attached to weather balloon 124 measure upper level wind speed, temperature, and air pressure. Controller 130 collects these measurements and transmits them to the remote tracking station 123 via transmitter 112. Controller 130 can be configured to automatically initiate rotating wind storm mitigating procedures if the sensors detect impending storm conditions. Controller 130 can also be configured to automatically initiate rotating wind storm mitigating procedures if it receives a warning issued by the Weather Bureau.

Engine 120 draws warm air 632 from predicted path 604 through inlets 108 from around the relatively warm surface of the Earth and projects exhaust 114 to form a rotating and rising column of heated air. This column of heated air acts to correct the atmospheric imbalance, like a naturally occurring rotating wind storm does. The relatively warm rising column of air displaces the cooler air in the upper level as it goes upward and forms a selectively small man-made rotating wind storm. The man-made rotating wind storm robs the strength of the naturally occurring rotating wind storm because there is less warm air to feed it.

Referring now to FIG. 5, device 100 is shown mounted to the bed of road going land vehicle 202. Base 102 is mounted to vehicle 202 with standard heavy duty attachments mechanisms common in the art. Vehicle 202 is any type of road going land vehicle capable of withstanding the thrust requirements of engine 120 without significant movement. In a preferred embodiment, vehicle 202 is a 4 ton flatbed truck. GPS antenna 122 is attached to base 102 and is used to locate and track vehicle 202. Vehicle 202 may be driven by an attendant or vehicle 202 may be operated remotely via remote control.

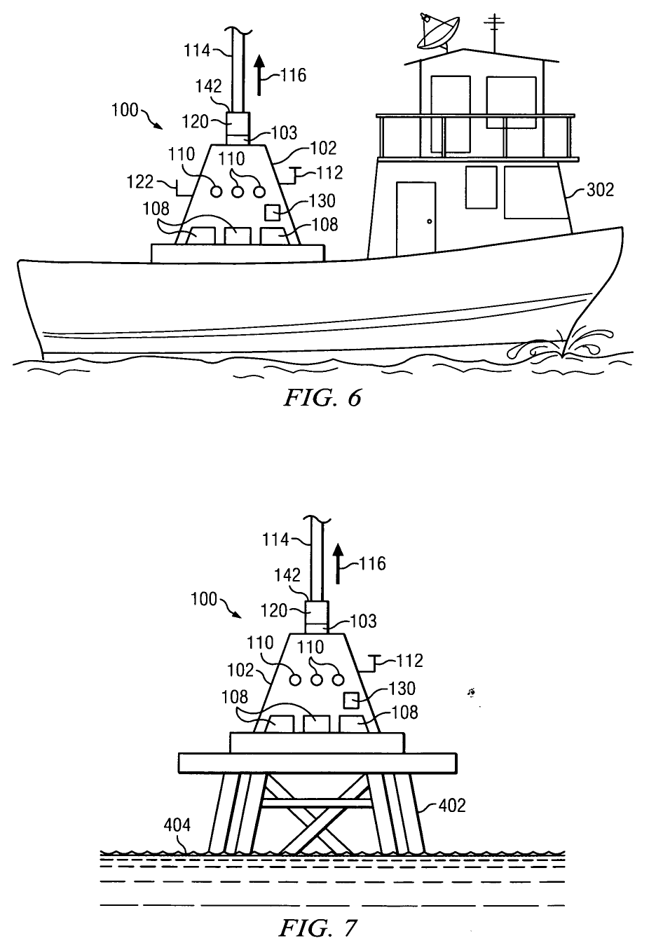

Referring now to FIG. 6, device 100 is shown secured to water going sea vehicle 302. Base 102 is mounted to the payload area of vehicle 302 with standard heavy duty attachment mechanisms common in the art. Vehicle 302 is any type of water going sea vehicle capable of withstanding the thrust requirements of engine 120 without compromising the buoyancy characteristics of vehicle 302. In a preferred embodiment, vehicle 302 is a heavy duty tugboat model. GPS antenna 122 is attached to base 102 and is used to locate and track vehicle 302. Vehicle 302 may be driven by an attendant or vehicle 302 may be operated remotely via remote control.

Referring now to FIG. 7, base 102 of device 100 is securely mounted to oil rig 402. Oil rig 402 is secured to a particular location over the ocean or sea 404 as is common in the art.

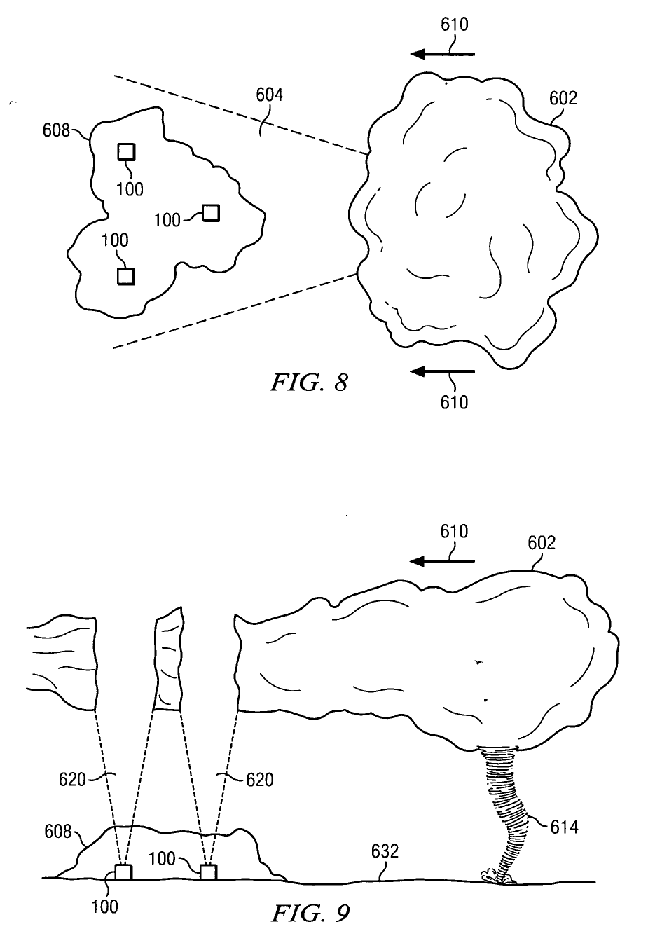

In use, as shown in FIGS. 8 and 9, the disclosed apparatus will initiate man-made “relief” rising columns of rotating warm air 620 that will provide one or more additional parallel paths to relieve atmospheric imbalance. The relief columns 620 will cool the nearby Earth's surface and surface air 608 and thus decrease the energy available to the impending naturally occurring rotating wind storm 614 and ideally prevent the naturally occurring wind storm from touching down or significantly decrease the strength of it and initiate the dissipating stage. The presence of the man-made relief columns of warm, rising air effectively speed up the lifecycle of the naturally occurring rotating wind storm to ultimately minimize the overall damaging effects of the storm.

Device 100 is positioned in the predicted path 604 of a rotating wind storm such as a tornado or hurricane. The position of device 100 can be permanently secured to the Earth's surface via piers 106 or oil rig 502 in areas known for frequent occurrence of rotating wind storms.

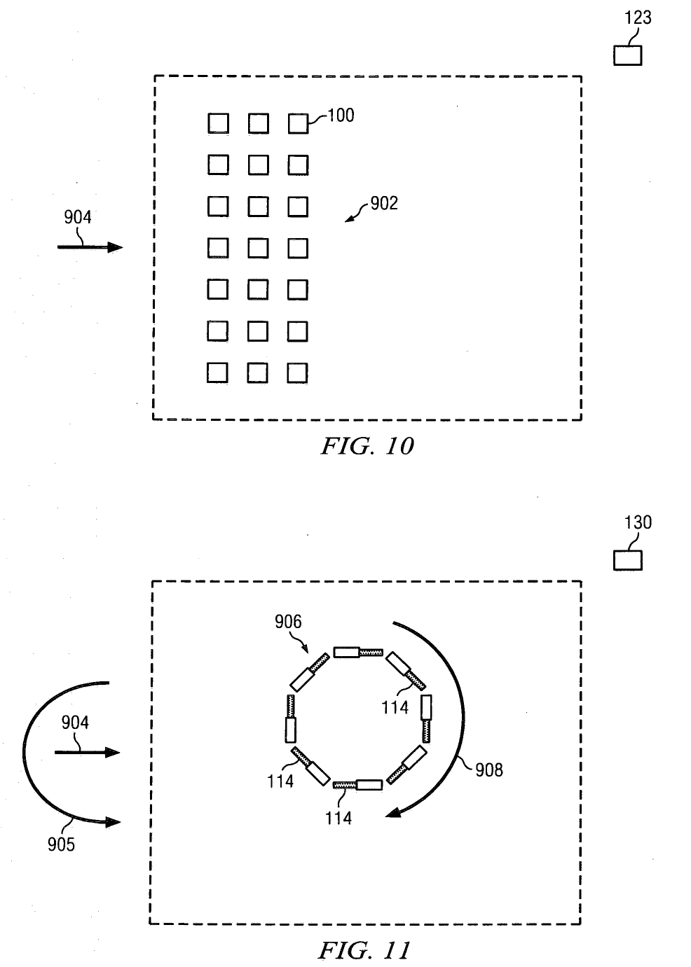

It is further envisioned in an alternate embodiment, that a plurality of engines can be formed into a matrix of engines 902. Referring to FIG. 10, it is preferred to have multiple man-made relief rotating wind storms to diminish the strength of the naturally occurring rotating wind storm and to minimize the likelihood that a relief rotating wind storm might get out of control. Engine matrix 902 may be configured in closely associated and generally parallel axes to permit sufficient horsepower to be generated to effect a high intensity tornado. The direction of the storm being indicated by 904. Each engine of the matrix of engines is in communication with remote controller 123.

Device 100 can also be positioned as needed via mobile units such as road going land vehicle 202 or water going sea vehicle 302. Additionally, the mobile units can be used to supplement an engine matrix.

The Weather Bureau constantly monitors weather conditions and issues warnings to those areas that are in the predicted path of an impending rotating wind storm. When a warning from the Weather Bureau is issued indicating conditions are good for the development of a rotating wind storm or there is currently a rotating wind storm moving across an area, the proper device 100 positioned in the predicted path is identified by remote tracking station 123. If no rotating wind storm mitigation devices 100 are permanently positioned in the predicted path, mobile units can be moved into position in the path of the impending rotating wind storm. Device 100 should be located within along the predicted path and generally 1 to 100 miles ahead of storm front 602. The storm front moves in the direction indicated by 610. In order to position device 100 sufficiently, it is preferred that multiple devices be utilized and initiated to best ensure mitigation of the impending rotating wind storm.

Once the proper rotating wind storm mitigation device 100 or devices is/are identified or a mobile unit or multiple mobile units is/are moved into place, engine 120 of each device 100 is run at full thrust for a duration of approximately 0.1 minute to 20 minutes or longer. The duration of engine 120 operation is determined by the ground speed of the oncoming rotating wind storm and whether conditions are still present for naturally occurring rotating wind storms.

During operation of device 100, controller 130 constantly manipulates the operation of engine 120 turning off and on and increasing and decreasing thrust based on automatic inputs received from sensors 110, sensors 132 and sensors 134 and based on inputs received from the remote tracking station. The exhaust from the jet engines naturally rotates as it exits the engine body. Therefore, each engine 120 can create a rising, rotating column of warm air individually. As the sensors monitor temperature, when the temperature at the Earth's surface cools and the temperature above the Earth's surface rises, the controller will reduce the thrust of the engine and direct the exhaust angles to be more vertical. As the sensors detect a change in wind speed, lower wind speeds will cause the controller to reduce the thrust of the engine and direct the exhaust angles to be more vertical. As the sensors monitor atmospheric pressure, when the pressure at the Earth's surface rises and the pressure above the Earth's surface lowers attempting to reach an equilibrium state, the controller will reduce the thrust of the engine and direct the exhaust angles to be more vertical.

Referring to FIG. 11, controller 130 can also redirect the angle engine 120 propels its exhaust 114 according to input from the sensors. The angle can be adjusted from generally vertical to generally perpendicular with the Earth's surface. In an alternate embodiment, through the use of an engine matrix pattern, the control panel can direct exhausts 114 from each engine in the engine matrix so that the exhausts intersect to create a rotating rising column of air larger than what is capable from single engine. The engine exhaust angles are adjusted to offset the rotation of the storm effect and thus encourage the rising relief columns of rotating warm air to create a vortex that rotates counter clockwise as seen from above in the Northern Hemisphere or clock-wise as seen from above in the Southern Hemisphere. FIG. 10 shows a circular patterned engine matrix 906 creating a clock-wise rotation 908. The direction of the storm being indicated by 904. The rotation of the storm indicated by 905.

Once the sensors detect that the storm has passed or controller 130 receives a signal from the Weather Bureau or the remote tracking station indicating that the rotating wind storm has passed or subsided, controller 130 will shut down engine 120 and resume normal monitoring operation procedures. It is understood that device 100 can be operated remotely or locally with a human attendant.

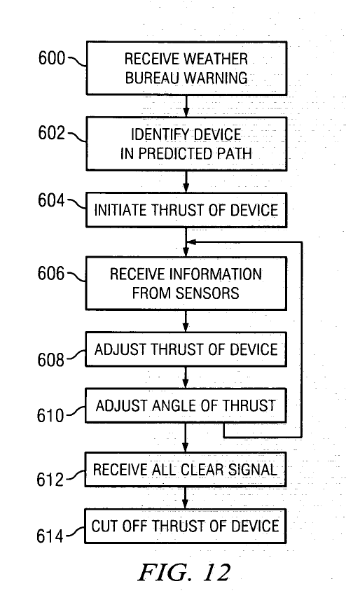

FIG. 12 shows the steps involved for initiating a rising column of air from the Earth's surface for the mitigation of a rotating wind storm identified by the Weather Bureau or the sensors of device 100. At step 600, device 100 receives a broadcast path data from the Weather Bureau indicating that a rotating wind storm is approaching or conditions are good for a rotating wind storm to develop. Step 602 identifies the device or plurality of devices in the predicted path of the approaching storm. At step 604, the thrust is initiated on the identified devices. At step 606, the controller receives atmospheric conditions information from the sensors of the identified devices. The controller adjusts the amount of thrust from the device at step 608. The controller adjusts the angle of the thrust from each device at step 610 in a concentrated set of directions. Steps 606 through 610 are repeated as necessary. At step 612, the controller receives information that the storm has passed or subsided. At step 614, the thrust from the identified devices is terminated.

As will be recognized by those skilled in the art, the innovative concepts described in the present application can be modified and varied over a tremendous range of applications, and accordingly the scope of patented subject matter is not limited by any of the specific exemplary teachings given.

1. An apparatus for mitigating a rotating wind storm in an unstable atmospheric system, the apparatus comprising:
a frame adjacent the Earth's surface in a path of the rotating wind storm;
an engine attached to the frame, having an intake and an exhaust;
a first set of sensors proximate the Earth's surface;
a second set of sensors attached at a first distance above the Earth's surface;
a controller in communication with the first set of sensors, the second set of sensors, and the engine; and
whereby the controller directs the engine to produce a thrust vector in a direction to reduce the temperature of a first mass of air proximate the Earth's surface and increase the temperature of a second mass of air spaced away from the Earth's surface thereby stabilizing the unstable atmospheric system.

2. The apparatus of claim 1, wherein the frame is attached to the Earth's surface.

3. The apparatus of claim 1 wherein the frame is movable with respect to the Earth's surface.

4. The apparatus of claim 1, wherein the frame is mobile and capable of traversing a body of water.

5. The apparatus of claim 1 wherein the direction ranges through an azimuth angle of about 0° to about 360° and through an altitude angle of about 0° to about 90°.

6. The apparatus of claim 1 wherein the first set of sensors and the second set of sensors measure temperature, pressure, wind speed, and wind direction.

7. The apparatus of claim 1 wherein the first distance ranges from ¼ mile to one mile.

8. The apparatus of claim 1 further comprising:
a second controller in communication with the first controller;
a set of path data, related to a path of the rotating wind storm;
the second controller in communication with a set of path data and programmed to remotely actuate the first controller.

9. An apparatus for mitigating a rotating wind storm in an unstable atmospheric system comprising:
a first controller, in communication with a set of path data predicting a path of the rotating wind storm;
a plurality of engines, positioned in the path of the rotating wind storm, producing a plurality of thrust vectors in a plurality of directions;
the plurality of directions dictated by the first controller to dispense the unstable atmospheric system.

10. The apparatus of claim 9 wherein the plurality of engines comprises a number of engines ranging between 300,000 and 350,000, arranged in a matrix and each of the plurality of directions forms a concerted pattern.

11. The apparatus of claim 10 wherein the concerted pattern creates a rotating helical spiral directed toward the unstable atmospheric system.

12. The apparatus of claim 10 wherein the concerted pattern creates a vertical draft cooling the Earth's surface.

13. The apparatus of claim 10 wherein the concerted pattern creates a circular pattern.

14. A method of initiating a rising column of warm air from the Earth's surface and cooling the Earth's surface for the mitigation of a rotating wind storm, the method comprising the steps of:
providing a mitigation device including a pivotally adjustable engine exhaust angle and a first set of sensors and a second set of sensors in communication with a controller where the controller is in communication with a remote tracking station;
receiving a set of data for a predicted path of the rotating wind storm;
identifying a mitigation device in the predicted path of the rotating wind storm;
activating the mitigation device;
receiving the temperature, pressure, wind speed, and wind direction information from the first set of sensors and the second set of sensors;
adjusting a thrust level of the mitigation device according to the first set of sensors and the second set of sensors;
adjusting a thrust angle of the mitigation device according to the first set of sensors and the second set of sensors;
receiving an all clear signal whereby the Earth's surface is cooled and the energy available to the rotating wind storm is decreased; and,
deactivating the mitigation device.

15. The method of claim 14 wherein the step of identifying a mitigation device further comprises identifying a matrix of mitigation devices.

16. The method of claim 14 wherein the steps of receiving information from the first set of sensors and the second set of sensors; adjusting the thrust level; and adjusting the thrust angle are repeated as necessary until the step of receiving an all clear signal is performed.

17. The method of claim 15 wherein the step of adjusting a thrust angle further comprises adjusting the thrust angle of each mitigation device in the matrix of mitigation devices so that the axes of the exhaust angles intersect and form a vortex.

18. The method of claim 14 wherein the step of receiving an all clear signal is received from the remote tracking station.

19. The method of claim 14 wherein the step of adjusting the thrust level further comprises adjusting the thrust level down when the temperature at the Earth's surface has decreased.

20. The method of claim 14 wherein the step of adjusting the thrust level further comprises adjusting the thrust level down with the pressure at the Earth's surface has risen.
